(19) United States
(12) Patent Application Publication
(10) Pub. No.: US 2025/0028590 A1
(43) Pub. Date: Jan. 23, 2025

(54) METHODS AND APPARATUS FOR SELF-MAINTENANCE OF SATELLITE-INTEGRATED NETWORKS

(71) Applicant: National Research Council of Canada, Ottawa (CA)

(72) Inventor: Peng HU, Waterloo (CA)

(21) Appl. No.: 18/713,688

(22) PCT Filed: Nov. 28, 2022
(86) PCT No.: PCT/CA2022/051737

§ 371 Date: May 27, 2024

(30) Foreign Application Priority Data
Nov. 26, 2021 (CA) 3148200

(51) Int. Cl. G06F 11/07; G06F 16/23; G06F 16/25

(52) U.S. Cl. CPC G06F 11/079; G06F 11/0706; G06F 11/0793; G06F 16/2365; G06F 16/258

(57) ABSTRACT

A computer-implemented method for communications network maintenance, the method comprising the steps of: acquiring raw data associated with the communications network a plurality of datasets; preprocessing the raw data by converting the raw data into a predefined data format to form a plurality of datasets and correcting any inconsistencies in the plurality of datasets; training a neural network with the plurality of datasets to detect at least one of an anomalous event and a network anomaly event, and localizing the communications network anomaly event to infer at least one root cause for the communications network anomaly event; and creating and executing a self-maintenance scheme to mitigate against effects of the at least one of the anomalous event and the communications network anomaly event.

### FIELD

Aspects of the disclosure relate to methods and systems for enabling autonomous self-maintenance for satellite integrated community networks.

### BACKGROUND

Satellite networks have long become a key connectivity option for community networks (CNs) [1] in unserved and underserved areas worldwide. With the international efforts on closing the “broadband gap” for digital divide including the implementation of new satellite network and telecommunications infrastructures in rural and remote areas, traditional satellite-dependent CNs (SDCNs) are envisioned to transform into satellite-integrated CNs (SICNs), featuring an integration of heterogeneous networks and segments to provide broadband, resilient, and agile end-to-end connections.

The integration of satellite and telecommunications networks has been discussed in the literature under the umbrella of space information networks, space terrestrial integrated networks, or space-air-ground integrated networks, where low earth orbit (LEO) satellites and high-altitude platform (HAP) components can be added for realizing backhaul links. While keeping the compatibility with SDCN, the new SICN paradigm allows the traditional SDCN users to access to the Internet through advanced satellite networks with fixed and/or wireless infrastructures, where the satellite can either be a backhaul link or supplementary to the backhaul options provided by terrestrial networks. In this context, the SICN will also include CNs which are currently non-satellite dependent and will add satellite backhauls to their existing connectivity options.

However, this transformation imposes unprecedented challenges to CN management centered on the assurance of critical operation together with low network management costs, high responsiveness and scalability. These challenges are often perceived as barriers and implicitly create a “management gap” for CNs. To close this gap, the SICN calls for self-maintainability leading to a responsive, autonomous, and scalable management solution. Such self-maintenance capability will also greatly enhance the critical role of CNs in supporting various applications for education, businesses, facilities, environmental monitoring, the Internet of Things, etc.

Although these new paradigms provide relevant discussions to SICNs, they have hardly addressed the self-maintenance topic. Self-maintenance in network management is an important task for SICNs, which requires autonomous identification, planning, and execution for fixes and upgrades of network resources. Today's machine learning (ML) methods provide a solid foundation for realizing self-maintenance for CNs. The overall use of ML on network management has been underpinned by the recent efforts from standards development organizations. The latest 3GPP Rel. 17 provides two management architectures for integrated satellite components with a 5G network. The ITU Telecommunication Standardization Sector (ITU-T) has identified the gaps to achieve the network 2030 goals and identified the architectural framework for ML in future networks. The European Telecommunications Standards Institute (ETSI) has created an industry specification group for the zero-touch network and service management, where largely autonomous networks without further human intervention are envisioned goals with the proposed means of network automation. However, despite these efforts there have been no specific solutions to self-maintenance for CNs.

Current ML methods are centered on network intrusion detection (NID) for cyberattacks, small-scale or special network setups, and anomaly detection using telemetry data on satellite and network devices [2]. The heterogeneity and complexity of connectivity options, architectures, and anomalous network events, including the high-impact low-frequency (HILF) incidents, will further make the ML-based solutions challenging on SICNs. For example, SICNs tend to use various architectures, technologies and scales. The expected use of new geosynchronous equatorial orbit (GEO) and non-geostationary orbit (NGSO) satellites requires new satellite terrestrial integrated network setups. With various technologies used in the access networks for geographically distributed communities, using ML methods in an integrated fashion with a combination of fixed, wireless, and satellite networks requires an approach with holistic thinking. This approach would need to accommodate additional entities on SICNs such as data centers (DCs) and Internet exchange points (IXPs), where these entities may be inconsistent across remote communities [3] and introduce anomalous events.

Rule-based reasoning under the umbrella of expert systems [7] has been a traditional approach to fault management where human experience is modelled with a set of condition-action rules. A codebook approach was considered to be superior to rule-based reasoning, where a knowledge base for identifying network failures with system events labeled is created as correlation matrices. These approaches can model the human experience or domain knowledge but their lack of flexibility as it is often difficult to create a codebook or a set of production rules for a network. Recent ML-based approaches mitigate the requirements for explicitly modelling the managed network with domain knowledge. A random forests (RF) algorithm was proposed [8] to detect the network failures for an industrial network setting based on the features from the device interface and virtual machine (VM) status, while the features and network sizes are not applicable to SICNs. A combined use of Bayesian networks and case-based analysis has been used in identifying the virtual private network (VPN) issues [9] but the network size is small. Border gateway protocol (BGP) data on autonomous systems (ASes) is introduced in [10], [11] for anomaly detection. ML-enabled automation in network service management has been presented in [12], where service quality states on a small network with six routers are projected using decision tree and gradient boosting algorithms. However, the current ML models target limited network resources and datasets on a special and small-scale network, which can hardly be applied to SICNs requiring high accuracy performance with efficient executions. A bi-level hierarchical classification methodology using ML has been proposed in [13] to identify the different types of secondary tasks drivers are engaged in using their driving behavior parameters. The authors in [14] indicated that splitting the classification task into sub-classification tasks can improve the accuracy rate on some non-BGP benchmark cyberattack datasets.

### SUMMARY

In one of its aspects, a computer-implemented method for communications network maintenance, the method comprising the steps of
acquiring raw data associated with the communications network a plurality of datasets;
preprocessing the raw data by converting the raw data into a predefined data format to form a plurality of datasets and correcting any inconsistencies in the plurality of datasets;
training a neural network with the plurality of datasets to detect at least one of an anomalous event and a network anomaly event, and localizing the communications network anomaly event to infer at least one root cause for the communications network anomaly event; and
creating and executing a self-maintenance scheme to mitigate against effects of the at least one of the anomalous event and the communications network anomaly event.

In another of its aspects, a computer readable medium storing instructions executable by a processor to carry out the operations for maintaining a communications networks, the operations comprising:
aggregating raw data from a plurality of data sources comprising at least one of communications network traffic data, diagnostic data, and communications network management data said raw data in a plurality of disparate formats;
transforming said raw data having the plurality of disparate formats into a single standard format to generate structured datasets;
extracting at least one feature of associated with the communications network from the structured data in accordance with one or more pre-programmed functions;
using a neural network model to build at least one predictive model;
inputting the structured data into the neural network using the plurality of input nodes;
training the neural network using said inputs until an error function associated with an output value that corresponds to an aspect of the communications network is minimized; and
using one or more weights from the neural network to identify a set structured data by element of value and output that will be used as an element of value summary for use as an input to each of the at least one predictive model;
wherein the at least one predictive model is useful for completing tasks comprising predicting at least one of an anomalous event and a communications network anomaly event.

In another of its aspects, a neural network unit comprising:
at least one processing unit; and
a non-transitory memory communicatively coupled to the at least one processing unit and comprising computer-readable program instructions that when executed by the at least one processing unit, cause the neural network unit to perform operations for self-maintenance of a communication network comprising a satellite-integrated communication network (SICN), the operations including:
training the neural network unit using a plurality of datasets associated with at least one of communications network traffic data, diagnostic data, and communications network management data, the neural network unit comprising at least one fully connected layer comprising a plurality of input nodes, a plurality of output nodes, and a plurality of connections for connecting each one of the plurality of input nodes to each one of the plurality of output nodes;
extracting at least one feature of associated with the communication network from the plurality of datasets in accordance with one or more pre-programmed functions;
building at least one predictive model;
inputting the plurality of datasets into the neural network using the plurality of input nodes;
wherein at least one predictive model is useful for completing tasks comprising predicting at least one of an anomalous event and a communication network anomaly event.

Advantageously, there is provided an ML-based hierarchical approach for self-maintenance solutions comprising ensemble and deep learning models for identifying anomalies and mitigation, which leverages various datasets and reduces learning time in computation without performance compromise.

### BRIEF DESCRIPTION OF THE DRAWINGS

Several exemplary embodiments of the present disclosure will now be described, by way of example only, with reference to the appended drawings in which:

FIG. 1 shows an overview of components and entities associated with the systems and methods, in accordance with some embodiments;

FIG. 2 shows a generic architecture of community networks;

FIG. 3 shows a hierarchical approach to self-maintenance for SICNs;

FIG. 4 shows an exemplary setup of a SICN; and

FIG. 5 shows performance improvements in ensemble and RNN methods.

### DETAILED DESCRIPTION OF EXEMPLARY EMBODIMENTS

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Moreover, it should be appreciated that the particular implementations shown and described herein are illustrative of the invention and are not intended to otherwise limit the scope of the present invention in any way. Indeed, for the sake of brevity, certain sub-components of the individual operating components, conventional data networking, application development and other functional aspects of the systems may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

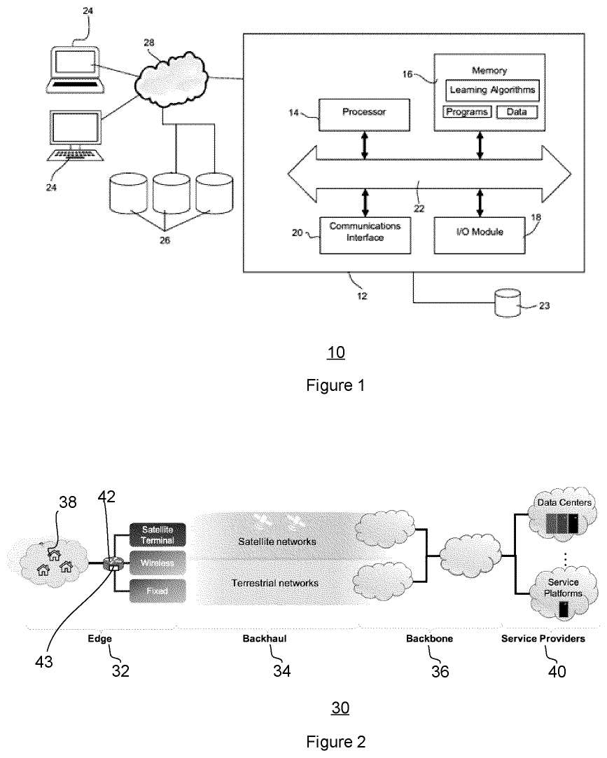

Referring to FIG. 1, there is shown an overview of a computing environment 10 of components configured to facilitate the systems and methods. It should be appreciated that the computing environment 10 is merely an example and that alternative or additional components are envisioned. Computing environment 10 comprises computing means with computing system 12, such as a server, comprising at least one processor such as processor 14, at least one memory device such as memory 16, input/output (I/O) module 18 and communications interface 20, which are in communication with each other via centralized circuit system 22. Although computing system 12 is depicted to include only one processor 14, computing system 12 may include a number of processors therein. In an embodiment, memory 16 is capable of storing machine executable instructions, data models and process models. Database 23 is coupled to computing system 12 and stores pre-processed data, model output data and audit data. Further, the processor 14 is capable of executing the instructions in memory 16 to implement aspects of processes described herein. For example, processor 14 may be embodied as an executor of software instructions, wherein the software instructions may specifically configure processor 14 to perform algorithms and/or operations described herein when the software instructions are executed. Alternatively, processor 14 may be execute hard-coded functionality. Computing environment 10 may be software (e.g., code segments compiled into machine code), hardware, embedded firmware, or a combination of software and hardware, according to various embodiments.

An example architecture of a satellite integrated community network (SICN) 30 is shown in FIG. 2, comprising edge segment 32, backhaul segment 34, and backbone segments 36 between community network (CN) 38 users and service providers 40. The CNs 38 are connected to the network edge 32 with at least a satellite frontend, backhaul links provided by satellite and/or terrestrial networks, and the backbone of the Internet. The edge portion 32 and backhaul portion 34 represent the locations most likely to require maintenance. The broadband access technologies shown in FIG. 2 can be categorized into fixed networks, including copper/cable and fiber optic options, wireless networks including cellular and microwave options, and satellite networks.

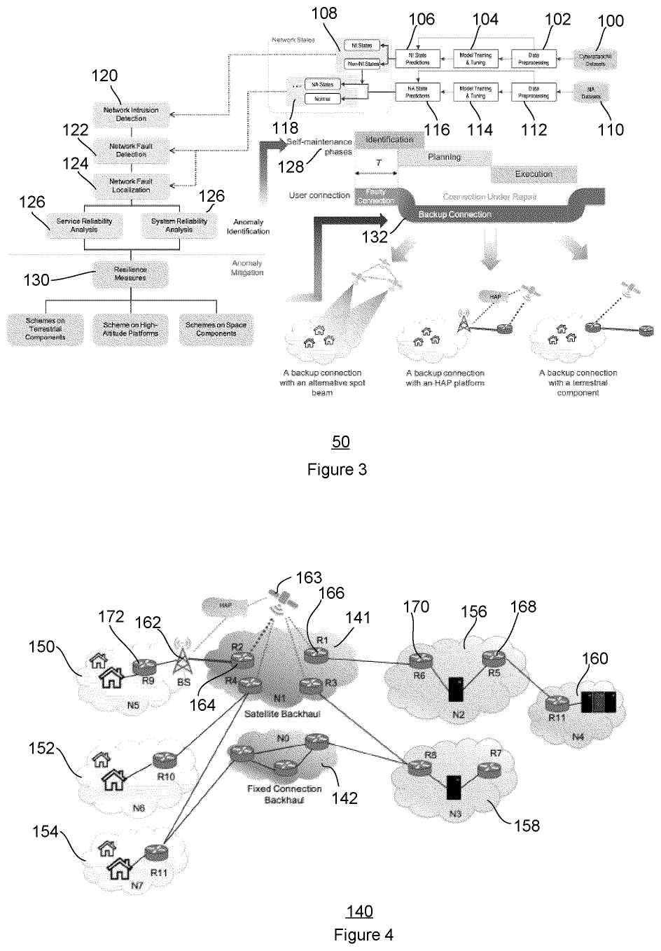

One important step in achieving self-maintainability is identifying the causes to anomalous network events. In one exemplary process, as shown in FIG. 3, once the faulty connection occurred on a user connection, the identification phase (P1) starts and a mitigation scheme is executed as part of the planning phase (P2), where a backup connection can be scheduled before the connection repair is done through the execution phase. The time T taken in the identification phase is essential for improving user experience, where the less the value of T the better. For a SICN 30, anomalous events may come from different network segments, the connections between them, and architectural entities such as an IXP or DC in between. However, there are a number of causes contributing to the anomalies. For example, within a satellite network, the anomalies [5] may come from the space environment (e.g., cosmic rays, the Van Allen radiation belts, etc.), mission degradation on subsystems/services, electrostatic charge, operation errors, and malicious actions. For LEO satellite constellations, these errors may result in faulty inter-satellite link (ISL) issues. The atmospheric conditions may contribute to the influence of the satellite-ground radiofrequency (RF) links. The failures on other network segments may result from the device hardware failures on network nodes, such as processors, storage devices, power modules, and network interfaces. Failures on a single compute node can cause various outage events, and ultimately affect network status or metrics, such as link state, packet loss, latency, throughput, and congestion. On the other hand, software failures from application endpoints will often result in abnormal application traffic. A self-maintenance process in the execution phase may initiate network automation tools to re-deploy the application services as a mitigation scheme.

Referring to FIG. 3, there is shown an ML-based hierarchical approach for self-maintenance capability in SICNs 30, represented in two general phases, i.e., anomaly identification phase (P1) and anomaly mitigation phase (P2) in flow chart 50. In one exemplary implementation, ML-based multi-class classification is formulated as a unified way of handling network intrusion detection (NID), network fault detection/localization, and service/system reliability analysis for the anomaly identification phase. The features extracted from the network flows are used to predict the network states, where multiple network anomalies caused by different factors can be considered, and the class labels represent the states. The states can be normal and abnormal states and extensible to multiple fine-grained states. The determination process of root causes to network anomalies following the hierarchical steps can be depicted in the ML pipeline shown on the top right portion of FIG. 3, where the cyberattack or network intrusion (NI) datasets and network anomaly (NA) datasets from various sources are utilized in the steps in the anomaly identification phase, including network intrusion detection, network fault detection and localization.

Generally, neural networks (sometimes called artificial neural networks (ANNs)) are used in various applications to estimate or approximate functions dependent on a set of inputs. Generally, neural networks are composed of a set of interconnected processing elements or nodes which process information by its dynamic state response to external inputs. Each neural network may consist of an input layer, one or more hidden layers, and an output layer. The one or more hidden layers are made up of interconnected nodes that process input via a system of weighted connections. Some neural networks are capable of updating by modifying their weights according to their training outputs, while other neural networks are “feedfoward” in which the information does not form a cycle.

In one example, the neural network employed by the systems and methods may analyze network data and output the nature of the network anomaly, and output a set of probabilities indicative of the anomaly having a root cause pertaining to a cyberattack or a network anomaly event. The server 12 may initially train the neural network using a set of training data obtained through different platforms and corresponding labels. The server 12 may train the neural network with the training data using various backpropagation or other training techniques. In particular, the server 12 may train the neural network by analyzing the inputted data and arriving at outputs(s). By recursively arriving at outputs, comparing the outputs to the training labels, and minimizing the error between the outputs and the training labels, the corresponding neural network(s) may train itself according to the input parameters. According to embodiments, the trained neural network(s) may be configured with a set of corresponding edge weights which enable the trained neural network(s) to analyze new inputted data and determine whether an anomaly is due to a network intrusion or a network fault. The server 12 may locally store, or otherwise be configured to access, the trained neural network(s). It should be appreciated that the server 12 may train the neural network according to various conventions or techniques, with varying amounts and sizes of training data. After the processing server 12 trains the neural network, the database 23 may store data associated with the trained neural network.

The implemented exemplary steps will now be described with reference to the flow chart 50. In the first phase (P1), before network intrusion detection (NID) can be performed, raw data obtained from cyberattacks is acquired (step 100), and preprocessed by converting the raw data into a predefined data format and determining whether there are any inconsistencies in the dataset, and sorting the datasets (step 102). Next, the datasets are employed to train a neural network classify anomalous events (step 104) and with a network intrusion state predictor model, or network intrusion predictive model, determining the network state (106), and the outcome is designated as either an NI state or an non-NI state (step 108).

Correspondingly, network fault detection and network fault localization is performed using the network anomaly datasets (step 110), followed by preprocessing a plurality of raw data by converting the data into a predefined data format and determining whether there are any inconsistencies in the dataset, and sorting the datasets (step 112). Next, the datasets are employed to train the neural network detect network anomaly events (step 114) and with a non-anomalous state predictor model, or non-anomalous state predictive model, determining the network state as being a network anomaly state or a normal state (step 116).

Once the network intrusion state predictor model has been trained, real-time communication network data and network management data network is ingested by the NI state predictor model which performs intrusion detection in real-time (step 120). Correspondingly, network fault detection is performed using the non-anomalous state predictor model (step 122), and localization of non-cyberattack anomalous events is performed to infer more specific causes (step 124). The root causes can be further identifiable through the service or system reliability analysis, which can be traced back to a level of the software service, device, or hardware component (step 126). These located causes will facilitate the planning and execution of self-maintenance activities, such as scheduling hardware/software fixes and dispatching repair resources from a network operations center (NOC) (step 128).

In the second phase (P2), the resilience measures are employed for mitigating outage links or malfunctioning devices (step 130), while on a SICN such resilience measures can be implemented through space, air or ground components such as redundant satellite channels, high altitude platform (HAPs), or base stations, with possible redundancy or fail-safe considerations (step 132). An example resilience measure using HAP is discussed in [6], where HAP entities considering unmanned aerial vehicles (UAVs) or balloons can be dispatched to mitigate link outage events between satellite and terrestrial components. The temporary links provided by HAP can continuously enable Internet access for community users in a SICN while meeting the key performance metrics.

Accordingly, types of anomalies in cyberattacks and faulty events are contemplated, where there are several differences between them. First, detecting cyberattacks is often used in NID systems that do not cover the faulty events of a network caused by, for example, device malfunctions, interface issues, or link outages. Second, NID is usually linked to attack countermeasures, not resilience measures. Third, NID can be deployed separately from other steps in FIG. 3. In this sense, existing NID systems or deployments can be leveraged. Last but not least, the separation between NID and fault detection is important as NID systems would need to handle a broad attack surface and may impose different requirements for data and compute resources than those in the subsequent steps.

The existing platforms or protocols provide means for collecting datasets for ML-based solutions, but they do not directly support out-of-the-box solutions to the self-maintenance needs for SICNs. The ML-based hierarchical approach is therefore essential to guide the data collection efforts and efficiently provide analytical results for self-maintainability.

Overall the data collection efforts can be performed with the network management activities, which are usually done at network operating centers (NOCs) with a team of staff members in a telecommunications organization. In a modern NOC that may manage enterprise networks, data centers, and service providers altogether, the management data can also be acquired from multiple network segments. This data can include the existing diagnostic data using Internet control message protocol (ICMP), and the data made available with the simple network management protocol (SNMP) setups to facilitate fault detection and diagnosis for a SICN. The SNMP's management information base (MIB) can include various management objects (MO) for monitoring managed resources. The latest SNMPv3 enhances the security features and can be used to set up a data collection model for proactive monitoring of hardware resources. With a software-defined networking platform, management data can be acquired with centralized controllers and functions. Moreover, analyzing the traces of network protocols provides another way to obtain data-driven insights into network issues. For example, BGP as an important protocol has been used to reveal the misconfigurations of the networks for network operations. As BGP maintains the routes of ASes of network service providers while provides a number of path parameters, it can be used to detect faults or anomalies. BGP has also been widely used in modern data centers following the Clos topology.

The methods and systems described herein may be deployed on top of underlying network architectures and infrastructures. For example, as shown in FIG. 2, an intelligent gateway (IGW) 43 on an edge router 42 close to the satellite terminal to implements self-maintenance capability for a SICN 30. This IGW can perform tasks, such as (a) making adaptive decisions on switching satellite links between Ka and C bands, or X and S bands, at the physical layer, including optical wireless communication networks, according to weather conditions, (b) detecting anomalies based on the network traffic and management data, (c) identifying malfunctioning network devices or components based on the management data from the adjacent entities, (d) responsively identifying the causes of network interruptions in the access network or beyond with assistance from the adjacent IGW entities, and (e) dispatching HAPs as a resilience scheme to fix link outages. More specifically, when identifying the network issues, the BGP and/or IPFIX/NetFlow data can be utilized at the IGW entities. In case of a network interruption, these entities can help progressively locate the root causes. BGP data [10] can be used to identify the cyberattack-related anomalies in contrast with normal states. The IGW entities with the support from a local IXP or DC [11] can have various BGP event data collected and analyzed with proper ML models to quickly identify the network issues and locate the faulty parts with high accuracy.

In yet another example, when a network service provider has separate NID entities close to the backbone segment as shown in FIG. 2, the NID tasks on the IGW end close to the edge segment can interact with the remote NID entities and thus offload the computation at the NID step. The interactions between NID entities can still be considered at the NID step in the anomaly identification phase. The use of an IGW intends to cause minimum physical changes to the existing networks for an SCIN and provide consistent service to users. The IGW 43 can be implemented as software entities running on existing network devices interfacing with satellite and terrestrial networks and with additional application services. The IGW 43 can also interact with various data collection entities, such as SNMP-based telemetry data collectors on the existing networks using separate management platforms to facilitate network fault localization. The IGW 43 can coordinate to execute a resilience measure and provide a bridged connection for users during a faulty connection. With the monitoring of link quality and atmospheric parameters for space-ground connections, the IGW module 43 may access a satellite network on a reliable channel optimally. Anomaly identification tasks are passively completed on the edge segment.

In one example, the methods and systems described herein are applied to a self-maintenance scenario on a SICN 140 shown in FIG. 4, in which satellite backhaul 141 and fixed connection backhaul 142 are connected to a SICN including three communities represented by local networks 150, 152, and 154, communicatively coupled to the backbone/service provider networks 156, 158, and 160 via backhauls 141, 142. Local network 150 represents a SICN setup with cellular distribution, while local network 152 represents the classical SDCN setup, and local network 154 represents another SICN setup with connection diversity provided by satellite and fixed connections. Local network 154 is connected to both satellite backhaul 141 and fixed connection backhaul 142, while local network 150 is connected to the cellular base station (BS) 162, which is connected to the satellite terminals 163 on router 164. This setup is representative and can be scaled up where additional network segments can be added on both ends of the satellite backhaul 141.

In one example, benchmark BGP datasets are employed to determine the effectiveness of various ML methods. Generally, BGP plays an important role in maintaining connectivity on network segments and gateways on a SICN. The SICN in FIG. 4 is set up in an emulated network, where satellite entities and routers are based on the Mininet virtual machines. Edge routers are added to each network as an AS to generate and log BGP traffic, and the traffic flows from the service providers to CN end-users through satellite backhaul 141 and fixed connection backhaul 142. The FRRouting protocol stack is used to configure BGP, and the external and internal BGP protocols are running between ASes and within an AS. BGP route information is periodically shared between routers as IGW entities and is stored in dump files. BGP datasets are logged when routers advertised their prefixes every few minutes. The data in dump files are then preprocessed by the Zebra dump parser and converted into tabular form for feature extraction used in [10].

With this generic SICN setup, a link outage is considered as a representative type of anomalous network events. In this case, a link outage may have resulted from cyberattacks, adverse weather conditions on the satellite backhaul link, and a number of device-specific problems. For BGP traffic on IGW entities, such an outage can cause a large number of withdrawals to be exchanged between peers as routers experience path interruptions and some networks become unreachable. After a period of time, new routes will be advertised by the routers. In case of anomalous network events, looking at the flow chart 50 of FIG. 3, the method follows steps 100-108 and 120 for NID, where the BGP NI datasets are used in [15]. Next, using additional BGP NA datasets available on the IGW 43, steps 110-118 and 122, 124 are followed for network fault detection and localization. In steps 100-108 and 120 corresponding to NID, the datasets have 37 features with an output with four labels, i.e., Other (0) and Code Red I (1), Nimda (2), and Slammer (3), where the labels 1-3 indicate some well-known cyberattack incidents, and the label 0 represents the possible normal traffic or additional anomalous types of outputs to be processed in steps 110-118 and 122, 124 for network fault detection and localization.

In steps 110-118 and 122, 124 corresponding to network fault detection and localization, BGP datasets on the edge routers are employed in order to further explore the outputs, where there are two link failures considered in the datasets: one is between router R1 166 and R2 164 on satellite backhaul 141 and the other is between R5 168 and R6 170 on backbone/service provider networks 156. Through the system analysis, the root cause analysis of the link outages can be narrowed down to the network interfaces on R1 166/R2 164 and R5 168/R6 170, respectively, using the system-specific datasets for identifying the root causes. The results of such a system reliability analysis step can lead to responsive and automated repair efforts of hardware or software issues, without necessarily affecting network access. In addition, the IGW entity on R2 164 or R9 172 may be used to commission a HAP to provide a temporary link between the BS 162 and satellite 163.

Multiple supervised machine learning algorithms are trained using past data for classification, such as, XGBoost, Neural Networks, Random Forest, and Logistic Regression. As an example, the XGBoost algorithm is able to automatically handle missing data values, and therefore it is sparse aware, includes block structure to support the parallelization of tree construction, and can further boost an already fitted model on new data i.e. continued training. In more detail, exemplary machine learning methods, as listed in Table I, including the NN-based algorithms were employed to solve a multi-class classification problem in the steps for network intrusion detection, network fault detection and network fault localization.

TABLE I
ACCURACY AND F1-SCORE
OF MAINSTREAM ML MODELS

| | |
|---|---|
| Step 1 | Step 2 |

| Model | Accuracy | F1-Score | Accuracy | F1-Score |
|---|---|---|---|---|
| NB | 0.749 | 0.770 | 0.950 | 0.783 |
| BN | 0.801 | 0.775 | 0.904 | 0.847 |
| LR | 0.795 | 0.755 | 0.951 | 0.940 |
| DT | 0.771 | 0.774 | 0.967 | 0.961 |
| RF | 0.839 | 0.821 | 0.970 | 0.961 |
| KNN | 0.807 | 0.797 | 0.962 | 0.952 |
| SVM | 0.781 | 0.692 | 0.932 | 0.905 |
| QDA | 0.756 | 0.696 | 0.943 | 0.928 |
| LSTM | 0.835 | 0.813 | 0.959 | 0.956 |
| GRU | 0.834 | 0.811 | 0.963 | 0.963 |
| BLS | 0.825 | 0.799 | 0.959 | 0.937 |
| XGBoost | 0.853 | 0.843 | 0.966 | 0.964 |

Naive Bayes (NB) is a basic probabilistic classifier which assumes the independence of input variables. Bayesian Network (BN) is an algorithm that can solve classification problems based on the posterior probability of each class given the features. The logistic regression (LR) and quadratic discriminant analysis (QDA) are parametric algorithms that can solve a classification problem. The decision tree (DT) is a classical nonparametric algorithm for solving classification problems, while it sometimes suffers the over-fitting problem. Random forest (RF) is a popular ensemble method that can resolve the over-fitting issue. Support vector machines (SVM) and k-Nearest Neighbors (KNN) are nonparametric classification algorithms that have been broadly used in the literature. Long-short term memory (LSTM) is a special kind of recurrent NN (RNN), a powerful NN for classification problems structured with input, hidden and output layers of neurons. LSTM addresses the gradient exploding problem of RNN and the gated recurrent unit (GRU) solves the gradient vanishing problem of LSTM. Broad Learning System (BLS) is employed based on an improved random vector functional link NN. The LSTM and GRU models are designed in a similar architecture: the first layer is an LSTM/GRU layer, followed by a fully connected layer with a ‘tanh’ activation and neurone equal to the dense units, and the last layer with a ‘softmax’ activation. Between these layers, two dropout layers are applied to avoid overfitting of the model.

Each model in Table I was trained on the datasets for two steps where the training sets are set to 60%, and the average accuracy and F1-Score values are obtained on test sets. Generally, ML algorithms with the same datasets are compared with the aforementioned preprocessing from BGP raw data with one exception for QDA, where the Fisher score was used to reduce the features to 12 on the NI dataset due to its assumption on the covariance matrix for each class. Extensively hyperparameter tuning is performed in the grid search method for most ML algorithms, and popular AutoML tools, tree-based pipeline optimization tool (TPOT) and Keras Tuner were used for hyperparameter tuning in applicable ML algorithms. The XGBoost model was tuned based on the results from TPOT. Due to the limited support for NN algorithms in TPOT, the Keras Tuner was used to tune hyperparameters in LSTM and GRU, where the optimal values of hyperparameters such as units and learning rates were searched in 200 epochs. The number of neighbors in KNN is set to 6 and 3 in Steps 1 and 2, respectively, while the number of estimators for RF is set to 200 and 60. For XGBoost, the maximum depth and minimum child weight are set to f3, 1 g and f1, 3 g with 100 estimators. For LSTM and GRU models, the hidden nodes, dense units and learning rates in Step 1 are set to f180, 80, 0.0001 g and f150, 200, 0.0001 g, respectively, followed by f40, 180, 0.001 g and f190, 120, 0.001 g in Step 2. For BLS, the ‘maptimes’ and ‘enhencetimes’ are set to f5, 5 g and f20, 50 g in Steps 1 and 2, respectively.

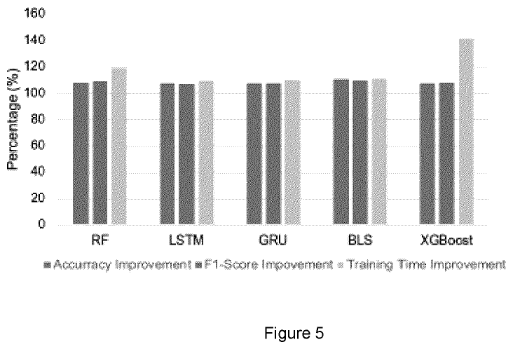

As can be seen in Table I, XGBoost, GRU, and RF have the best overall performance, while LSTM still has consistently good performance, followed by BLS in comparison to other ML methods. DT only has good performance in Step 2 but has under 77.5% accuracy and F1-Score in Step 1. FIG. 5 shows the top-performing ML methods can also achieve improvements in training time, F1-Score, and accuracy, compared with the non-hierarchical approach, where the fault detection is based on the combined datasets in one shot. BLS has the most significant improvement in accuracy to 111%, followed by GRU and RF (108.1%), LSTM (107.6%), and XGBoost (107.4%). The F1-Score is improved in BLS to 109.5%, followed by RF (109%), XGBoost (107.9%), GRU (107.3%), and LSTM (106.7%). XGBoost leads the improvement in training time to 141.1%), followed by RF (118.6%), BLS (111%), GRU (110.1%) and LSTM (109.4%). The results indicate the RNN methods (GRU and LSTM) and ensemble methods (XGBoost and RF) perform anomaly identification effectively.

In one implementation, processor 14 may be embodied as a multi-core processor, a single core processor, or a combination of one or more multi-core processors and one or more single core processors. For example, processor 14 may be embodied as one or more of various processing devices, such as a coprocessor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, Application-Specific Standard Products (ASSPs), System-on-a-chip systems (SOCs), Complex Programmable Logic Devices (CPLDs), Programmable Logic Controllers (PLC), Graphics Processing Units (GPUs), and the like. For example, some or all of the device functionality or method sequences may be performed by one or more hardware logic components.

Memory 16 may be embodied as one or more volatile memory devices, one or more non-volatile memory devices, and/or a combination of one or more volatile memory devices and non-volatile memory devices. For example, memory 16 may be embodied as magnetic storage devices (such as hard disk drives, floppy disks, magnetic tapes, etc.), optical magnetic storage devices (e.g., magneto-optical disks), CD-ROM (compact disc read only memory), CD-R (compact disc recordable), CD-R/W (compact disc rewritable), DVD (Digital Versatile Disc), BD (BLU-RAY™ Disc), and semiconductor memories (such as mask ROM, PROM (programmable ROM), EPROM (erasable PROM), flash ROM, RAM (random access memory), etc.).

I/O module 18 facilitates provisioning of an output to a user of computing system 12 and/or for receiving an input from the user of computing system 12, and send/receive communications to/from the various sensors, components, and actuators of computing environment 10. I/O module 18 may be in communication with processor 14 and memory 16. Examples of the I/O module 18 include, but are not limited to, an input interface and/or an output interface. Some examples of the input interface may include, but are not limited to, a keyboard, a mouse, a joystick, a keypad, a touch screen, soft keys, a microphone, and the like. Some examples of the output interface may include, but are not limited to, a microphone, a speaker, a ringer, a vibrator, a light emitting diode display, a thin-film transistor (TFT) display, a liquid crystal display, an active-matrix organic light-emitting diode (AMOLED) display, and the like. In an example embodiment, processor 14 may include I/O circuitry for controlling at least some functions of one or more elements of I/O module 18, such as, for example, a speaker, a microphone, a display, and/or the like. Processor 14 and/or the I/O circuitry may control one or more functions of the one or more elements of I/O module 18 through computer program instructions, for example, software and/or firmware, stored on a memory, for example, the memory 16, and/or the like, accessible to the processor 14.

In an embodiment, various components of computing system 12, such as processor 14, memory 16, I/O module 18 and communications interface 20 may communicate with each other via or through a centralized circuit system 22. Centralized circuit system 22 provides or enables communication between the components (14-20) of computing system 12. In certain embodiments, centralized circuit system 22 may be a central printed circuit board (PCB) such as a motherboard, a main board, a system board, or a logic board. Centralized circuit system 22 may also, or alternatively, include other printed circuit assemblies (PCAs) or communication channel media.

Communications interface 20 enables computing system 12 to communicate with other entities over various types of wired, wireless or combinations of wired and wireless networks, such as for example, the Internet. In at least one example embodiment, communications interface 20 includes a transceiver circuitry for enabling transmission and reception of data signals over the various types of communication networks. In some embodiments, communications interface 20 may include appropriate data compression and encoding mechanisms for securely transmitting and receiving data over the communication networks. Communications interface 20 facilitates communication between computing system 12 and I/O peripherals.

Centralized circuit system 22 may be various devices for providing or enabling communication between the components (12-20) of computing system 12. In certain embodiments, centralized circuit system 22 may be a central printed circuit board (PCB) such as a motherboard, a main board, a system board, or a logic board. Centralized circuit system 22 may also, or alternatively, include other printed circuit assemblies (PCAs), communication channel media or bus.

A plurality of user computing devices 24 and data sources 26 are coupled to computing system 12 with communication network 28. User computing devices 24 can therefore access computing environment 10 to run queries and receive requested communication network insights and predictions based on the communication network data and network management data from data sources 26.

It is noted that various example embodiments as described herein may be implemented in a wide variety of devices, network configurations and applications.

Those of skill in the art will appreciate that other embodiments of the disclosure may be practiced in network computing environments with many types of computer system configurations, including personal computers (PCs), industrial PCs, desktop PCs), hand-held devices, multi-processor systems, microprocessor-based or programmable consumer electronics, network PCs, server computers, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

In another implementation, computing environment 10 follows a cloud computing model, by providing an on-demand network access to a shared pool of configurable computing resources (e.g., servers, storage, applications, and/or services) that can be rapidly provisioned and released with minimal or nor resource management effort, including interaction with a service provider, by a user (operator of a thin client).

The benefits and advantages described above may relate to one embodiment or may relate to several embodiments. The embodiments are not limited to those that solve any or all of the stated problems or those that have any or all of the stated benefits and advantages. The operations of the methods described herein may be carried out in any suitable order, or simultaneously where appropriate. Additionally, individual blocks may be added or deleted from any of the methods without departing from the spirit and scope of the subject matter described herein. Aspects of any of the examples described above may be combined with aspects of any of the other examples described to form further examples without losing the effect sought.

The above description is given by way of example only and various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as critical, required, or essential features or elements of any or all the claims. As used herein, the terms “comprises,” “comprising,” or any other variations thereof, are intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as “essential” or “critical.”

The preceding detailed description of exemplary embodiments of the invention makes reference to the accompanying drawings, which show the exemplary embodiment by way of illustration. While these exemplary embodiments are described in sufficient detail to enable those skilled in the art to practice the invention, it should be understood that other embodiments may be realized and that logical and mechanical changes may be made without departing from the spirit and scope of the invention. For example, the steps recited in any of the method or process claims may be executed in any order and are not limited to the order presented. Thus, the preceding detailed description is presented for purposes of illustration only and not of limitation, and the scope of the invention is defined by the preceding description, and with respect to the attached claims.

### REFERENCES

[1] P. Micholia, M. Karaliopoulos, I. Koutsopoulos et al., “Community Networks and Sustainability: A Survey of Perceptions, Practices, and Proposed Solutions,” IEEE Communications Surveys & Tutorials, vol. 20, no. 4, pp. 3581-3606, 2018.
[2] F. Pacheco, E. Exposito, and M. Gineste, “A framework to classify heterogeneous Internet traffic with Machine Learning and Deep Learning techniques for satellite communications,” Computer Networks, vol. 173, p. 107213, 2020.
[3] W. Waites, J. Sweet, R. Baig et al., “RemIX: A Distributed Internet Exchange for Remote and Rural Networks,” in Proceedings of the 2016 Workshop on Global Access to the Internet for All, ser. GAIA '16. New York, NY, USA: ACM, 2016, pp. 25-30.
[4] J. Saldana, A. Arcia-Moret, B. Braem et al., “Alternative network deployments: taxonomy, characterization, technologies,” RFC Editor, RFC 7962, 2016.
[5] D. A. Galvan, B. Hemenway, W. W. IV et al., “Satellite Anomalies,” in Satellite Anomalies, ser. Benefits of a Centralized Anomaly Database and Methods for Securely Sharing Information Among Satellite Operators. RAND Corporation, jun 2014, pp. 7-28.
[6] A. H. Arani, P. Hu, and Y. Zhu, “Fairness-aware link optimization for space-terrestrial integrated networks: A reinforcement learning framework,” IEEE Access, vol. 9, pp. 77 624-77 636, 2021.
[7] W. Fuller, “Network management using expert diagnostics,” International Journal of Network Management, vol. 9, no. 4, pp. 199-208, July 1999.
[8] J. M. N. Gonzalez, J. A. Jimenez, J. C. D. Lopez et al., “Root Cause Analysis of Network Failures Using Machine Learning and Summarization Techniques,” IEEE Communications Magazine, vol. 55, no. 9, pp. 126-131, 2017.
[9] L. Bennacer, Y. Amirat, A. Chibani et al., “Self-Diagnosis Technique for Virtual Private Networks Combining Bayesian Networks and Case-Based Reasoning,” IEEE Transactions on Automation Science and Engineering, vol. 12, no. 1, pp. 354-366, 2015.
[10] Z. Li, A. L. G. Rios, G. Xu et al., “Machine Learning Techniques for Classifying Network Anomalies and Intrusions,” in 2019 IEEE International Symposium on Circuits and Systems (ISCAS), 2019, pp. 1-5.
[11] N. P. Lopes and A. Rybalchenko, “Fast BGP Simulation of Large Datacenters BT—Verification, Model Checking, and Abstract Interpretation,” C. Enea and R. Piskac, Eds. Chain: Springer International Publishing, 2019, pp. 386-408.
[12] Y. Turk, E. Zeydan, and Z. Bilgin, “A Machine Learning Based Management System for Network Services,” in 2019 International Conference on Wireless and Mobile Computing, Networking and Communications (WiMob), oct 2019, pp. 1-8.
[13] O. A. Osman, M. Hajij, S. Karbalaieali et al., “A hierarchical machine learning classification approach for secondary task identification from observed driving behavior data,” Accident Analysis & Prevention, vol. 123, pp. 274-281, 2019.
[14] F. Alin, A. Chemchem, F. Nolot et al., “Towards a hierarchical deep learning approach for intrusion detection,” in Machine Learning for Networking, S. Boumerdassi, E. Renault, and P. Muhlethaler, Eds. Chain: Springer International Publishing, 2020, pp. 15-27.
[15] B. Al-Musawi, P. Branch, and G. Armitage, “BGP Anomaly Detection Techniques: A Survey,” IEEE Communications Surveys & Tutorials, vol. 19, no. 1, pp. 377-396, 2017.

1. A computer-implemented method for communications network maintenance, the method comprising the steps of:
acquiring raw data associated with the communications network a plurality of datasets;
preprocessing the raw data by converting the raw data into a predefined data format to form a plurality of datasets and correcting any inconsistencies in the plurality of datasets;
training a neural network with the plurality of datasets to detect at least one of an anomalous event and a network anomaly event, and localizing the communications network anomaly event to infer at least one root cause for the communications network anomaly event; and
creating and executing a self-maintenance scheme to mitigate against effects of the at least one of the anomalous event and the communications network anomaly event.

2. The computer-implemented method of claim 1, comprising a further step of determining at least one root cause by analyzing a reliability value associated with at least one of a software service, a device, and a component, associated with the communications network.

3. The computer-implemented method of claim 2, comprising a further step of scheduling at least one of a hardware repair and a software fix and dispatching repair resources.

4. The computer-implemented method of claim 3, comprising a further step of employing resilience measures for mitigating against the communications network anomaly event, such that the communications network is self-maintaining.

5. The computer-implemented method of claim 4, wherein the communications network comprises a satellite-integrated communication network (SICN).

6. The computer-implemented method of claim 5, wherein the resilience measures on the satellite integrated community network (SICN) are implemented through at least one of a space component, an air component, and a ground component.

7. The computer-implemented method of claim 6, wherein the at least one of the space, air and ground components comprises at least one of satellite channels, high altitude platforms (HAPs), and base stations, wherein each of the components is associated with a redundant or fail-safe component.

8. The computer-implemented method of claim 7, wherein the satellite-integrated communication network (SICN) comprises an intelligent gateway (IGW) in communication with at least one satellite terminal.

9. The computer-implemented method of claim 8, wherein the intelligent gateway performs adaptive decisions on switching satellite links between frequency bands at a physical layer depending on the links' connectivity.

10. The computer-implemented method of claim 9, wherein the raw data comprises at least one of communications network traffic data, diagnostic data, and communications network management data.

11. The computer-implemented method of claim 8, wherein the intelligent gateway detects anomalies based on the at least one of communications network traffic data, diagnostic data, and communications network management data.

12. The computer-implemented method of claim 11, wherein the intelligent gateway identifies malfunctioning network devices or components based on the management data from adjacent network nodes.

13. The computer-implemented method of claim 8, wherein the intelligent gateway responsively identifies the causes of network interruptions with the assistance from adjacent IGW entities.

14. The computer-implemented method of claim 8, wherein the intelligent gateway dispatches HAPs as a resilience scheme to fix link outages.

15. The computer-implemented method of claim 8, wherein the intelligent gateway analyzes the plurality of datasets and uses predictive models to identify issues with the communication network and locate faulty parts of the communication network.

16. The computer-implemented method of claim 15, wherein features extracted from the plurality of datasets are employed to determine at least one of a network intrusion, and a network fault, and localize the communications network fault, and perform service and/or system reliability analysis to identify the communications network anomaly.

17. The computer-implemented method of claim 16, wherein the predictive model is trained to predict network states, wherein the network states are assigned class labels comprising at least one of a normal state, an abnormal state, and a fine-grained state.

18. The computer-implemented method of claim 17, wherein the plurality of datasets comprise existing diagnostic data using Internet control message protocol (ICMP), and data made available with the simple network management protocol (SNMP) setups, and Border Gateway Protocol (BGP) routing data.

19. The computer-implemented method of any one of claims 1 to 18, wherein the neural network comprises at least one of an XGBoost, gated recurrent unit (GRU), Random Forest, long short-term memory (LSTM) and broad learning system (BLS) model.

20. The computer-implemented method of claim 19, wherein the neural network outputs a set of probabilities indicative of the nature of the communications network anomaly.

21. The computer-implemented method of claim 8, wherein the intelligent gateway performs adaptive decisions on switching satellite links between frequency bands at a physical layer and an optical wireless communication network depending on the links' connectivity.

22. A computer readable medium storing instructions executable by a processor to carry out the operations for maintaining a communications networks, the operations comprising:
aggregating raw data from a plurality of data sources comprising at least one of communications network traffic data, diagnostic data, and communications network management data said raw data in a plurality of disparate formats;
transforming said raw data having the plurality of disparate formats into a single standard format to generate structured datasets;
extracting at least one feature of associated with the communications network from the structured data in accordance with one or more pre-programmed functions;
using a neural network model to build at least one predictive model;
inputting the structured data into the neural network using the plurality of input nodes;
training the neural network using said inputs until an error function associated with an output value that corresponds to an aspect of the communications network is minimized; and
using one or more weights from the neural network to identify a set structured data by element of value and output that will be used as an element of value summary for use as an input to each of the at least one predictive model;
wherein the at least one predictive model is useful for completing tasks comprising predicting at least one of an anomalous event and a communications network anomaly event.

23. The computer readable medium of claim 22, wherein features extracted from the structured data are employed to determine at least one of a communications network intrusion, and a communications network fault, and localize the communications network fault, and perform service and/or system reliability analysis to identify the at least one of the anomalous event and the communications network anomaly event.

24. The computer readable medium of claim 23, wherein the communications network comprises a satellite-integrated communication network (SICN).

25. The computer readable medium of claim 24, further comprising mitigating against the at least one of the anomalous event and the communications network anomaly event with resilience measures, such that the communications network is self-maintaining.

26. The computer readable medium of claim 25, wherein the resilience measures on the satellite integrated community network (SICN) are implemented through at least one of a space component, an air component, and a ground component.

27. The computer readable medium of claim 26, wherein the at least one of the space, air and ground components comprises at least one of satellite channels, high altitude platforms (HAPs), and base stations, wherein each of the components is associated with a redundant or fail-safe component.

28. The computer readable medium of claim 27, wherein the satellite-integrated communication network (SICN) comprises an intelligent gateway in communication with at least one satellite terminal.

29. The computer readable medium of claim 22, wherein the raw data comprises existing diagnostic data using Internet control message protocol (ICMP), and data made available with simple network management protocol (SNMP) setups, and Border Gateway Protocol (BGP) routing data.

30. The computer readable medium of claim 29, wherein the neural network outputs a set of probabilities indicative of the nature of the communications network anomaly.

31. The computer readable medium of claim 30, wherein the at least one predictive model is at least one of an XGBoost, gated recurrent unit (GRU), Random Forest, long short-term memory (LSTM) and broad learning system (BLS) model.

32. A neural network unit comprising:
at least one processing unit; and
a non-transitory memory communicatively coupled to the at least one processing unit and comprising computer-readable program instructions that when executed by the at least one processing unit, cause the neural network unit to perform operations for self-maintenance of a communication network comprising a satellite-integrated communication network (SICN), the operations including:
training the neural network unit using a plurality of datasets associated with at least one of communications network traffic data, diagnostic data, and communications network management data, the neural network unit comprising at least one fully connected layer comprising a plurality of input nodes, a plurality of output nodes, and a plurality of connections for connecting each one of the plurality of input nodes to each one of the plurality of output nodes;
extracting at least one feature of associated with the communication network from the plurality of datasets in accordance with one or more pre-programmed functions;
building at least one predictive model;
inputting the plurality of datasets into the neural network using the plurality of input nodes;
wherein at least one predictive model is useful for completing tasks comprising predicting at least one of an anomalous event and a communication network anomaly event.

33. The neural network unit of claim 32, wherein features extracted from the plurality of datasets are employed to determine at least one of a communications network intrusion, and a communications network fault, and localize the communications network fault, and perform service and/or system reliability analysis to identify the at least one of the anomalous event and the communications network anomaly event.

34. The neural network unit of claim 33, wherein the communications network comprises a satellite-integrated communication network (SICN).

35. The neural network unit of claim 34, further comprising mitigating against the at least one of the anomalous event and the communications network anomaly event with resilience measures, such that the communications network is self-maintaining.

36. The neural network unit of claim 35, wherein the resilience measures on the satellite integrated community network (SICN) are implemented through at least one of a space component, an air component, and a ground component.

37. The neural network unit of claim 36, wherein the at least one of the space, air and ground components comprises at least one of redundant satellite channels, high altitude platforms (HAPs), and base stations, wherein each of the components is associated with a redundant or fail-safe component.

38. The neural network unit of claim of claim 37, wherein the satellite-integrated communication network (SICN) comprises an intelligent gateway in communication with at least one satellite terminal.

39. The neural network unit of claim 38, wherein the plurality of datasets comprises existing diagnostic data using Internet control message protocol (ICMP), and data made available with simple network management protocol (SNMP) setups, and Border Gateway Protocol (BGP) routing data.

40. The neural network unit of claim 39, wherein the at least one predictive model is at least one of an XGBoost, gated recurrent unit (GRU), Random Forest, long short-term memory (LSTM) and broad learning system (BLS) model.
